(19) United States
(12) Patent Application Publication
(10) Pub. No.: US 2026/0066648 A1
(43) Pub. Date: Mar. 5, 2026

(54) POWER CONTROL SYSTEM AND VEHICLE COMPRISING THE SAME

(71) Applicants: Hyundai Motor Company, Seoul (KR); Kia Corporation, Seoul (KR); EGTRONICS Co., Ltd., Hwaseong-si (KR)

(72) Inventors: Soon Cheol Hwang, Hwaseong-Si (KR); Chan Woo Jeong, Hwaseong-Si (KR); Yoon Kyu Shin, Osan-Si (KR); Ji Hyeong Lee, Hwaseong-Si (KR); Eun Jin Jung, Seongnam-Si (KR); Chan Ho Kang, Suwon-Si (KR); Meong Kyu Choi, Yongin-Si (KR)

(21) Appl. No.: 19/172,023

(22) Filed: Apr. 7, 2025

(30) Foreign Application Priority Data
Aug. 27, 2024 (KR) 10-2024-0115283

(51) Int. Cl. H02J 1/10; B60L 3/00; B60L 50/60

(52) U.S. Cl. CPC H02J 1/10; B60L 3/003; B60L 50/60; H02J 2105/37

(57) ABSTRACT

A power control system according to one embodiment of the present disclosure includes: a first converter configured to convert a voltage of a high-voltage battery into a first voltage; a first battery; a first power distributor configured to distribute power of the first converter to the first battery and first voltage loads; a second converter configured to convert the voltage of the high-voltage battery into a second voltage; a second battery; a second power distributor configured to distribute power of the second converter to the second battery and second voltage loads; and a bidirectional converter connected between the first power distributor and the second power distributor. Here, each of the first power distributor and/or the second power distributor includes at least one switch and controls the at least one switch to be turned on or off in response to occurrence of a set failure state.

### CROSS-REFERENCE TO RELATED APPLICATIONS

The present application claims priority to Korean Patent Application No. 10-2024-0115283, filed on Aug. 27, 2024, the entire contents of which is incorporated herein by reference in its entirety for all purposes.

### TECHNICAL FIELD

The present disclosure relates to a power control system and a vehicle including the same.

### BACKGROUND

In an electronic device, stable power supply is important.

In particular, the stable power supply is important for vehicles because an accident may occur by a device malfunction caused by a power supply failure.

For example, if the power supply failure occurs in an autonomous vehicle, a limitation (e.g., an operational malfunction, an operational incapability, etc.) may occur in vehicle control due to an autonomous driving system, and the limitation may increase a risk of accident.

Thus, the autonomous vehicle may require a measure for the power supply failure, and redundancy power supply may be required as the measure.

Although some redundancy power supply technologies for general electronic devices are available, a technology suitable for autonomous vehicles is required.

For example, redundancy power supply technology that is able to manage various failure situations may be required for autonomous vehicles.

The matters described in this Background section are only for the enhancement of understanding of the background of the disclosure, and should not be taken as acknowledgment that they correspond to prior art already known to those skilled in the art.

### SUMMARY

One or more features of the present disclosure provides a redundancy power supply technology capable of managing various failure states.

One or more features of the present disclosure provides a technology capable of effectively blocking a connected power supply line and supplying redundancy power when a failure occurs in a converter or a battery that receives power from the converter.

Also, one or more features of the present disclosure prevents loss of redundancy power and occurrence of fire by blocking a connected power line in a failure or short-circuit state of a converter or battery.

A power control system may comprise: a first connector configured to be connected with a first battery; a first converter configured to convert a voltage of a main battery to a first voltage, wherein the first voltage corresponds to a voltage of the first battery; a first power distributor configured to distribute power output from the first converter to the first battery and first voltage loads; a second connector configured to be connected with a second battery; a second converter configured to convert the voltage of the main battery to a second voltage different from the first voltage, wherein the second voltage corresponds to a voltage of the second battery; a second power distributor configured to distribute power output from the second converter to the second battery and second voltage loads; and a bidirectional converter connected between the first power distributor and the second power distributor, wherein at least one of the first power distributor or the second power distributor comprises at least one switch and is configured to control the at least one switch to be turned on or off in response to a failure associated with at least one circuit element.

The at least one switch of the first power distributor may comprise a first switch configured to electrically connect the bidirectional converter with the first converter or electrically disconnect the bidirectional converter from the first converter.

The first switch may be configured to be turned off to electrically disconnect the bidirectional converter from the first converter in response to a failure or short-circuit in the first converter.

The power control system may be configured to maintain, during a failure or short-circuit in the first converter, the first switch in an on-state in response to a signal from a controller.

The at least one switch of the first power distributor may comprise a second switch configured to: electrically connect the first battery with the first converter or the bidirectional converter; or electrically disconnect the first battery from the first converter or the bidirectional converter.

The second switch may be configured to be turned off in response to a failure or complete discharge of the first battery.

The at least one switch of the second power distributor may comprise a third switch configured to electrically connect the second converter with the bidirectional converter or electrically disconnect the second converter from the bidirectional converter.

The third switch may be configured to be turned off to electrically disconnect the second converter from the bidirectional converter in response to a failure or short-circuit in the second converter.

The power control system may be configured to maintain, during a failure or short-circuit in the second converter, the third switch in an on-state in response to a signal from a controller.

The at least one switch of the second power distributor may comprise a fourth switch configured to: electrically connect the second battery with the second converter or the bidirectional converter; or electrically disconnect the second battery from the second converter or the bidirectional converter.

The fourth switch may be configured to be turned off in response to a failure or complete discharge of the second battery.

The bidirectional converter may be configured to convert the second voltage to the first voltage in response to a failure or short-circuit in the first converter.

The bidirectional converter may be configured to convert the first voltage to the second voltage in response to a failure or short-circuit in the second converter.

The first voltage loads may comprise at least one first load associated with vehicle driving and at least one second load associated with a vehicle function other than vehicle driving, and the first power distributor may comprise a first main power line configured to connect the first converter to each load of the first voltage loads and a first redundancy power line configured to connect the first battery and the bidirectional converter in parallel to the at least one first load.

The at least one switch of the first power distributor may comprise a first switch connected between the first main power line and the first redundancy power line. Absence of a failure or short-circuit in the first converter, the first switch is configured to be maintained in an on-state, the at least one first load is configured to receive first power through the first main power line and second power through the first redundancy power line, and the at least one second load is configured to receive power through the first main power line, and in response to a failure or short-circuit in the first converter, the first switch is configured to be turned off, and the first power supplied to the at least one first load is blocked while supply of the second power is maintained.

The at least one first load may comprise at least one of a steering device, a braking device, an integrated body-control unit (IBU), or a communication gateway, and the at least one second load may comprise at least one of an air conditioner, an audio video navigation (AVN), a cabin lighting device, a seat position adjustment device, or a seat heating wire.

The second voltage loads may comprise at least one third load associated with vehicle driving and at least one fourth load associated with a vehicle function other than vehicle driving, and the second power distributor may comprise a second main power line configured to connect the second converter to each load of the second voltage loads and a second redundancy power line configured to connect the second battery and the bidirectional converter in parallel to the at least one third load.

The at least one switch of the second power distributor may comprise a third switch connected between the second main power line and the second redundancy power line. Absence of a failure or short-circuit in the second converter, the third switch is configured to be maintained in an on-state, the at least one third load is configured to receive third power through the second main power line and fourth power through the second redundancy power line, and the at least one fourth load is configured to receive power through the second main power line, in response to a failure or short-circuit in the second converter, the third switch is configured to be turned off, and the third power supplied to the at least one third load is blocked while supply of the fourth power is maintained, and the at least one third load comprises an autonomous driving system.

A vehicle may comprise: a main battery; a first battery; a first converter configured to convert a voltage of the main battery to a first voltage, wherein the first voltage corresponds to a voltage of the first battery; a first power distributor configured to distribute power output from the first converter to the first battery and first voltage loads; a second battery; a second converter configured to convert the voltage of the main battery to a second voltage different from the first voltage, wherein the second voltage corresponds to a voltage of the second battery; a second power distributor configured to distribute power output from the second converter to the second battery and second voltage loads; and a bidirectional converter connected between the first power distributor and the second power distributor, wherein at least one of the first power distributor or the second power distributor comprises at least one switch and is configured to control the at least one switch to be turned on or off in response to occurrence of a failure associated with at least one circuit element of the vehicle.

A power control system for a vehicle may comprise: a first power distributor configured to distribute power to first voltage loads via at least one of a plurality of first power lines, wherein the first power distributor comprises: a first connector configured to be connected with a first battery, wherein a voltage of the first battery corresponds to a first voltage; and a second connector configured to receive first power from a first converter configured to convert a voltage of a main battery to the first voltage; a second power distributor configured to distribute power to second voltage loads via at least one of a plurality of second power lines, wherein the second power distributor comprises: a third connector configured to be connected with a second battery, wherein a voltage of the second battery corresponds to a second voltage different from the first voltage; and a fourth connector configured to receive second power from a second converter configured to convert the voltage of the main battery to the second voltage; and a bidirectional converter connected between the first power distributor and the second power distributor, wherein the bidirectional converter is configured to: based on a failure associated with power supply via the second connector, provide power from the second power distributor to the first power distributor; and based on a failure associated with power supply via the fourth connector, provide power from the first power distributor to the second power distributor.

### BRIEF DESCRIPTION OF THE DRAWINGS

FIG. 1 is a view illustrating a power control system.

FIG. 2 is a view illustrating an example of a current flow in a normal state of the power control system in FIG. 1.

FIG. 3 is a view illustrating an example of a current flow in a failure state of a first converter of the power control system of FIG. 1.

FIG. 4 is a view illustrating an example of a current flow in a short-circuit state of the first converter of the power control system of FIG. 1.

FIG. 5 is a view illustrating an example of a current flow in a short-circuit state of a first battery of the power control system of FIG. 1.

FIG. 6 is a view illustrating an example of a current flow in a failure state of a second converter of the power control system of FIG. 1.

FIG. 7 is a view illustrating an example of a current flow in a short-circuit state of a second converter of the power control system of FIG. 1.

FIG. 8 is a view illustrating an example of a current flow in a short-circuit state of a second battery of the power control system of FIG. 1.

FIG. 9 is a view illustrating another example of the current flow in the short-circuit state of the first converter of the power control system of FIG. 1.

FIG. 10 is a view illustrating another example of the current flow in the failure state of the second converter of the power control system of FIG. 1.

### DETAILED DESCRIPTION

Since the present disclosure may have diverse modified embodiments, some exemplary examples are illustrated in the drawings and are described in the detailed description of the disclosure. However, this does not limit the present disclosure within the specific embodiment(s) and it should be understood that the present disclosure covers all the modifications, equivalents, and replacements within the idea and technical scope of the present disclosure.

In this specification, the suffixes “module” and “unit” are used merely for nominal distinction between components and should not be interpreted as implying that the components are physically or chemically separated or that they may be separated.

Throughout the present disclosure, references to components, units, or modules generally refer to items that logically can be grouped together to perform a function or group of related functions. Like reference numerals are generally intended to refer to the same or similar components. Components, units, and modules may be implemented in software, hardware or a combination of software and hardware. The components, units, modules, and/or functions described above may be implemented and/or performed by one or more processors. For examples, the components, units, and/or modules may include processor(s), microprocessor(s), graphics processing unit(s), logic circuit(s), dedicated circuit(s), application-specific integrated circuit(s), programmable array logic, field-programmable gate array(s), controller(s), microcontroller(s), and/or other suitable hardware. The components, units, and/or modules may also include software control module(s) implemented with a processor or logic circuitry for example. The components, units, and/or modules may include or otherwise be able to access memory such as, for example, one or more non-transitory computer-readable storage media, such as random-access memory, read-only memory, electrically erasable programmable read-only memory, erasable programmable read-only memory, flash/other memory device(s), data registrar(s), database(s), and/or other suitable hardware. One or more storage type media may include any or all of the tangible memory of computers, processors, or the like, or associated modules thereof, such as various semiconductor memories, tape drives, disk drives and the like, which may provide non-transitory storage at any time for software programming.

It will be understood that although the terms of “first” and “second” are used herein to describe various elements, these elements should not be limited by these terms. These terms may be used solely to differentiate one component from another in name, and their sequential meanings are understood through the context of the description rather than by the names themselves.

The term “and/or” is used to include all possible combinations of the listed items. For example, “A and/or B” includes all three cases of “A”, “B”, and “A and B”.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, and C”, “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

It will also be understood that when an element is referred to as being “connected to” or “engaged with” another element, it may be directly connected to the other element, or intervening elements may also be present.

In the following description, the technical terms are used only for explaining a specific exemplary embodiment while not limiting the present disclosure. The terms of a singular form may include plural forms unless referred to the contrary. The meaning of ‘include’ or ‘comprise’ specifies a property, a region, a fixed number, a step, a process, an element and/or a component but does not exclude other properties, regions, fixed numbers, steps, processes, elements and/or components.

Unless terms used in the present disclosure are defined differently, the terms may be construed as meaning known to those skilled in the art. Terms such as terms that are generally used and have been in dictionaries should be construed as having meanings matched with contextual meanings in the art. In this description, unless defined clearly, terms are not ideally, excessively construed as formal meanings.

Also, the terms unit, control unit, control device, or controller are widely used to name devices that control specific functions and do not refer to a generic functional unit. Also, the devices denoted by the names may include a communication device that communicates with another controller or sensor to control the corresponding function, a computer-readable recording medium that stores an operation system, a logic command, and input/output information, and at least one processor that performs determinations, decisions, and calculations required for function control.

On the other hand, the processor may include semiconductor integrated circuits and/or electronic elements that perform at least one or more of comparisons, determinations, calculations, and decisions to achieve programmed functions. For example, the processor may be a computer, a microprocessor, CPU, ASIC, an electronic circuitry (logic circuits), or a combination thereof.

Also, the computer readable recording medium (or memory) includes all sorts of data storage devices that store computer readable data. For example, the computer readable recording medium may include at least one of a flash memory type, hard disk type, micro type, card type (e.g., secure digital (SD) card) or eXtream digital (XD) type memory and a random access memory (RAM), static RAM (SRAM), read-only memory (ROM), programmable ROM (PROM), electrically erasable PROM (EEPROM), magnetic RAM (MRAM), magnetic disk, or optical disk type memory.

These recording media may be electrically connected to the processor, and the processor may read data from and write data to the recording media. The recording media and the processor may be integrated with each other or physically separated from each other.

Hereinafter, various examples of the present disclosure will be described with reference to the accompanying drawings.

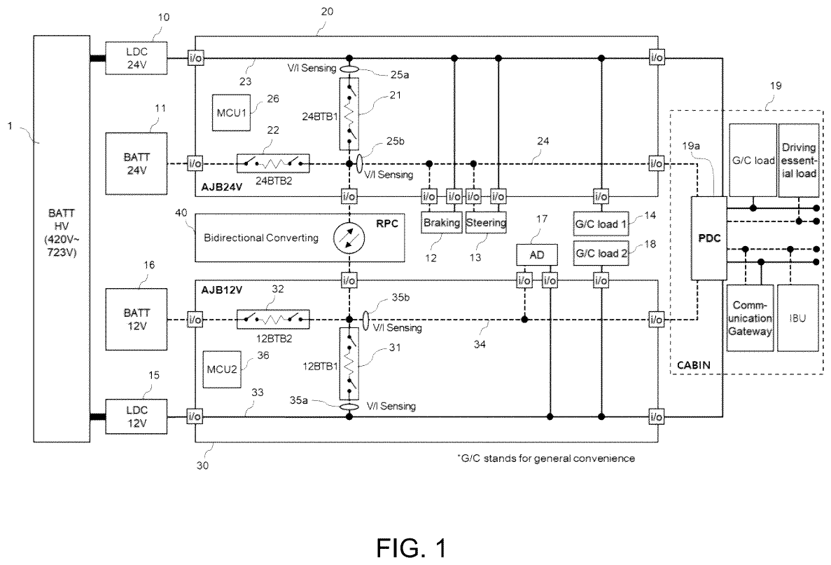

FIG. 1 is a view illustrating a topology of the power control system of an automatic driving vehicle as a power control system.

A vehicle may include one or more batteries (e.g., a high-voltage battery 1 as a main battery).

The high-voltage battery 1 may include a plurality of battery cells (not shown) that output a voltage of, e.g., 2.7 V to 4.2 V, and the set number of the plurality of battery cells may be connected in series or parallel to form one battery module. The high-voltage battery 1 may be packaged such that one or more battery modules are connected in series or parallel as one battery to output, e.g., about 400 V, about 800 V, or several kV.

The power control system may include a first power system and a second power system, and the two systems may function mutually as redundancy power systems.

For example, power of a first battery 11 may be used as redundancy power in case of failure of the first converter 40. However, if the power is not sufficient, the second power system may be used as a redundancy power supply source. Likewise, the first power system may serve as a redundancy power supply source for the second power system in a similar manner.

A bidirectional converter 40 may be connected between the first power system and the second power system so that both the power systems serve as the redundancy power systems for each other as described above. The bidirectional converter 40 may convert a first voltage to a second voltage and the second voltage to the first voltage. The first voltage may correspond to a voltage provided by the first battery 11, and the second voltage may correspond to a voltage provided by a second battery 12.

First, the first power system may include a first converter 10 and a first power distributor 20.

The first converter 10 may convert a voltage of the high-voltage battery 1 to the first voltage.

Although the first voltage may be, e.g., a voltage of 24V as a rated voltage, aspects of the present disclosure are not limited thereto.

The first converter 10 may (e.g., continuously) output 28V power by converting the power of the high-voltage battery 1, for example, when a startup state of an electric vehicle is an ‘EV Ready’ state.

The first battery 11 that is a battery having a rated voltage of 24V may include a plurality of batteries (e.g., two 12V lead-acid batteries).

The first power distributer 20 may distribute the power supplied from the first converter 10 to the first battery 10 and first voltage loads.

To this end, the first power distributer 20 may include a first power line 23 that connects the first converter 10 to the first voltage loads and a first redundancy power line 24 that connects the first battery 11 and the bidirectional converter 40 in parallel to the first voltage loads.

Also, the first power distributor 20 may include a first switch 21 that turns on/off electrical connection between the second power system and the first converter and a second switch 22 that turns on/off electrical connection between the second power system and the first battery 11 and electrical connection between the first converter 10 and the first battery 11.

In this example, the first switch 21 is connected between the first power line 23 and the first redundancy power line 24, and the second switch 22 turns on/off the electrical connection between the first battery 11 and the first voltage loads on the first redundancy power line 24 or turns on/off the electrical connection between the bidirectional converter 40 and the first battery 11 in redundancy power supply performed by the second power system.

The first power distributor 20 may include a first controller 26 that controls the first switch 21 and the second switch 22 depending on a state of the first converter 10 and/or the first battery 11.

The first controller 26 may include a micro controller unit (MCU). That is, the first controller 26 may include a memory in which a control logic computer program is stored and a microprocessor that loads and executes the program from the memory.

Also, the first power distributor 20 may include a first sensor 25a for sensing a voltage and/or current output from the first converter 10 and a second sensor 25b for sensing a voltage and/or current output from the first battery 11.

The first sensor 25a may be disposed between the first power line 23 and the first switch 21, and the second sensor 25b may be disposed at a rear end of a connection point between the first switch 21 and the first redundancy power line 24 (e.g., a point between the connection point and a terminal connected to an interior power distributor 19a).

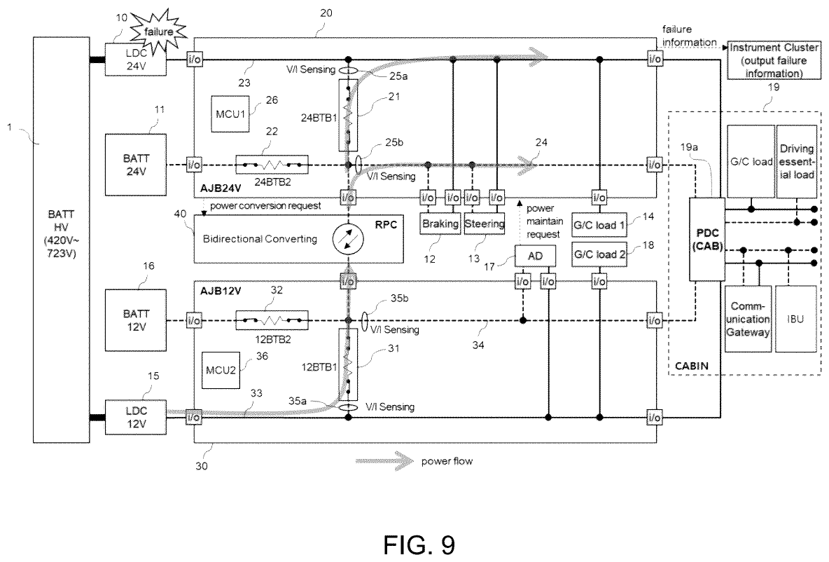

Although the first sensor 25a senses an output of the first converter 10 in a normal state (e.g., absence of a circuit failure, a system failure, etc.), the first sensor 25a may also sense a voltage and/or current of the redundancy power in a state in which the redundancy power is supplied through the second power system (e.g., examples described with respect to FIG. 9).

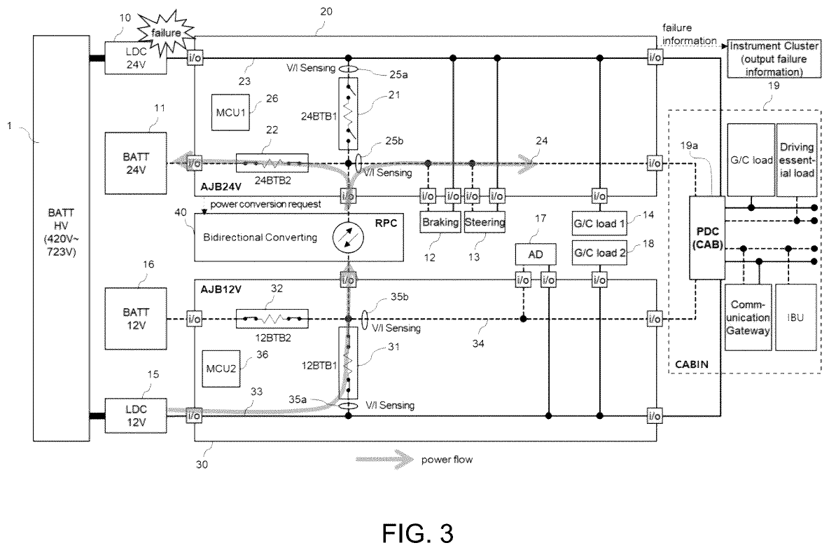

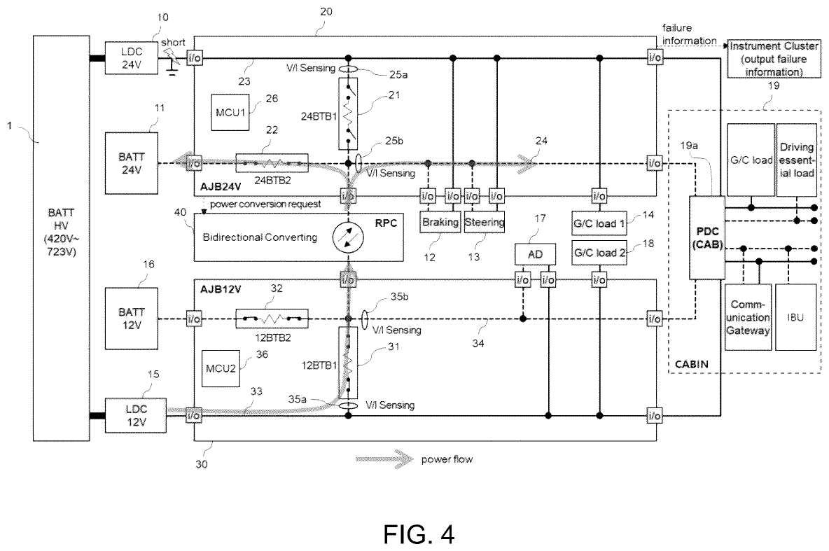

Also, although the second sensor 25b senses an output of the first battery 11 in a normal state, the second sensor 25b may also sense a voltage and/or current of the redundancy power in a state in which the redundancy power is supplied through the second power system (e.g., examples described with respect to FIGS. 3 and 4).

Each of the first switch 21 and the second switch 22 may be a mechanical relay, a back-to-back switch, or a switch of another type.

The back-to-back switch may include an integrated circuit (IC) and a plurality of field effect transistors (FET) and sense a current/voltage independently to allow the IC to control a gate voltage of the FET based on the sensed current/voltage, thereby turning on/off a bidirectional current flow through the FET. Here, if the current is greater than a first reference value, the back-to-back switch may block the current flow (e.g., by the hardware system), for example, through gate voltage control of the IC, to block a current flow generated when a large capacity of overcurrent occurs. For example, if one of the first voltage loads consumes a large capacity of current, the back-to-back switch may be automatically turned off (e.g., by the hardware system) to block the current flow.

Also, if an amount of current output to the first voltage loads is equal to or greater than a second reference value, the first controller 26 may transmit a control command to the back-to-back switch by using values received from sensors that sense a voltage and current. The back-to-back switch may be turned off according to the control command received from the first controller to block the current flow. Here, the second reference value may be less than the above-described first reference value.

The second power system may include a second converter 15 and a second power distributor 30.

The second converter 15 may convert the voltage of the high-voltage battery 1 into the second voltage. The second voltage may correspond to a voltage provided by the second battery 16, and the second voltage may correspond to a voltage provided by the second battery 16.

Although the second voltage may be, e.g., a voltage of 12V as a rated voltage, aspects of the present disclosure are not limited thereto.

The second converter 15 may (e.g., continuously) output 14V power by converting the power of the high-voltage battery 1 when a startup state of the electric vehicle is the ‘EV Ready’ state.

The second battery 16 that is a battery having a rated voltage of 12V may include one or more batteries (e.g., one 12V lead-acid battery).

The second power distributer 30 may distribute the power supplied from the second converter 15 to the second battery 16 and second voltage loads.

To this end, the second power distributer 30 may include a second power line 33 that connects the second converter 15 to the second voltage loads and a second redundancy power line 34 that connects the second battery 16 and the bidirectional converter 40 in parallel to the second voltage loads.

Also, the second power distributor 30 may include a third switch 31 that turns on/off electrical connection between the first power system and the second converter and a fourth switch 32 that turns on/off electrical connection between the first power system and the second battery 16 and electrical connection between the second converter 15 and the second battery 16.

In this example, the third switch 31 is connected between the second power line 33 and the second redundancy power line 34, and the fourth switch 32 is connected between the second battery 16 and the second voltage loads on the second redundancy power line 34. The fourth switch 32 is also connected between the bidirectional converter 40 and the second battery 16 in redundancy power supply performed by the first power system.

The second power distributor 30 may include a second controller 36 that controls the third switch 31 and the fourth switch 32 depending on a state of the second converter 15 and/or the second battery 16.

As described above, the second controller 36 may also include a memory in which a corresponding control logic computer program is stored and a microprocessor that loads and executes the program from the memory.

The second power distributor 30 may include a third sensor 35a for sensing a voltage and/or current output from the second converter 15 and a fourth sensor 35b for sensing a voltage and/or current output from the second battery 16.

The third sensor 35a may be disposed between the second power line 33 and the third switch 31, and the fourth sensor 35b may be disposed at a rear end of a connection point between the third switch 31 and the second redundancy power line 34 (e.g., a point between the connection point between the third switch 31 and the second redundancy power line 34 and a second terminal connected to the interior power distributor 19a).

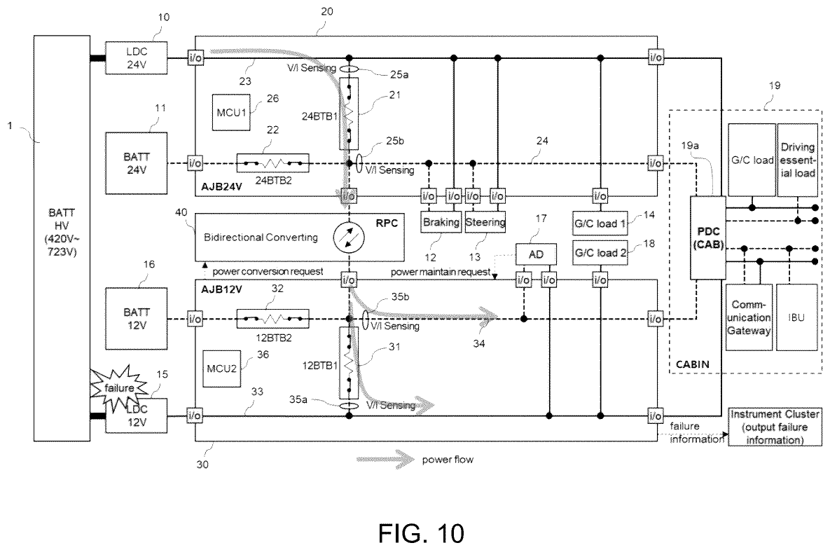

Although the third sensor 35a senses an output of the second converter 15 in a normal state, the third sensor 35a may also sense a voltage and/or current of the redundancy power in a state in which the redundancy power is supplied through the first power system (e.g., examples described with respect to FIG. 10).

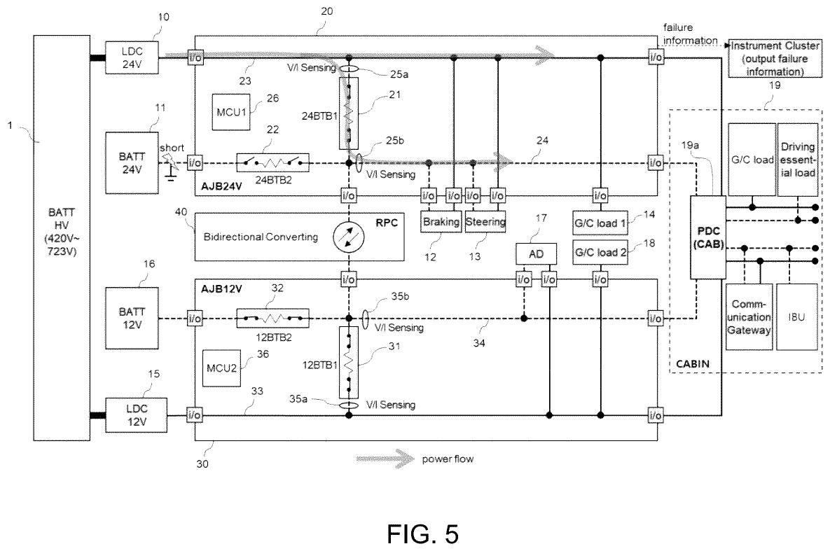

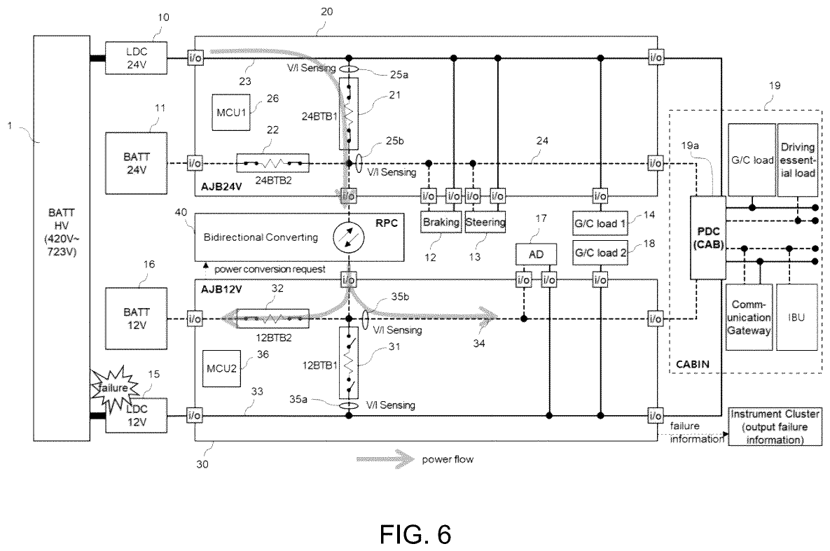

Also, although the fourth sensor 35b senses an output of the second battery 16 in a normal state, the fourth sensor 35b may also sense a voltage and/or current of the redundancy power in a state in which the redundancy power is supplied through the first power system (e.g., examples described with respect to FIGS. 5 and 6).

Each of the third switch 31 and the fourth switch 32 may be a mechanical relay, a back-to-back switch, or a switch of another type.

In this example, each of the first power distributor 20 and the second power distributor 30 may be implemented as an active junction block including two back-to-back switches, a junction block circuit for power distribution, and a controller for controlling the same.

Although some junction boxes may include only a fuse relay, the active junction block in the example described above may include a micro-controller unit 26 or 36 (or both) to actively control switches 21, 22, 31 and 32 and a relay through monitoring of a voltage and current through sensors 25a, 25b, 35a, and 35b. Here, the relay may be disposed in the active junction block to connect or disconnect a current flow for the first voltage loads or the second voltage loads.

The bidirectional converter 40 may selectively perform bidirectional voltage conversion between the first voltage and the second voltage.

The bidirectional converter 40 may convert the second voltage to the first voltage based on a signal that triggers the power conversion from the second voltage to the first voltage being received from the first power distributor 20 and convert the first voltage to the second voltage based on a signal that triggers the power conversion from the first voltage to the second voltage being received from the second power distributor 30.

The first power distributor 20 and the second power distributor 30 may indicate a target current and voltage via a conversion request signal to the bidirectional converter 40. Based on the received conversion request signal, the bidirectional converter 40 may convert an inner switch to be turned on, thereby allowing the current flow and performing the power conversion through the conversion circuit.

If the power conversion request signals from the first power distributor 20 and the second power distributor 30 are overlapped in time, a corresponding operation may be stopped when the conversion operation is being performed.

For example, if the conversion request signal from the second power distributor 30 is received while the power conversion requested from the first power distributor 20 is being performed, the conversion operation being performed may be stopped. Similarly, if the conversion request signal from the first power distributor 20 is received while the power conversion requested from the second power distributor 30 is being performed, the conversion operation being performed may be stopped.

In another example, if the power conversion requests from the first power distributor 20 and the second power distributor 30 are received before completing an ongoing power conversion according to a first conversion request signal, a first requested conversion according to the first conversion request signal may be performed, and a subsequently requested conversion according to a second conversion request signal may not be performed.

The bidirectional converter 40 may include a micro controller unit, a voltage conversion circuit for voltage boosting and dropping, and a back-to-back switch disposed between the voltage conversion circuit and a high-voltage side. For example, the bidirectional converter 40 may be configured as a 2.5 kW-class single package, which is advantageous in terms of layouts and costs.

In this example, the first voltage loads represent electronic devices driven by using the first voltage as a rated voltage, and the second voltage loads represent electronic devices driven by using the second voltage as a rated voltage.

The first voltage loads include first loads that are used for vehicle driving and second loads that are not used for vehicle driving (e.g., but used for auxiliary devices of the vehicle).

For example, the first loads may include a braking device 12, a steering device 13, an integrated body-control unit (IBU), a communication gateway among electronic devices in a vehicle, and other loads for vehicle driving (e.g., an instrument cluster).

The second loads may include an electronic device 14 for general purposes or for user convenience. The term “electronic device for general purposes or for convenience” may be used for other functions that are not related to vehicle driving. The electronic device 14 for general purposes or for user convenience may be different from the devices for vehicle driving and may refer to electronic devices in the vehicle other than the devices 19 for vehicle driving.

For example, the electronic device for general purposes or for user convenience may include an air conditioning device, an audio/video device, interior lighting, seat position control, and seat heating wires.

Likewise, the second voltage loads may include third loads and fourth loads.

For example, the third loads may include an autonomous driving system 17 and a device for vehicle driving, which is driven by the second voltage among the electronic devices in the vehicle, and the fourth loads may include an electronic device 18 for general purposes or for user convenience, which is driven by the second voltage.

Here, the autonomous driving system 17 may include all sorts of sensors necessary for autonomous driving (e.g., LiDAR, a radar, an ultrasonic sensor, a sensor for detecting a vehicle state including a vehicle speed) and an autonomous driving controller (e.g., a processor and a memory in which an autonomous driving logic is stored).

In this example, the first redundancy power line 24 and the second redundancy power line 34 may be connected to supply power only to the device(s) for vehicle driving and may not supply power to other devices (i.e., devices other than the devices for vehicle driving, and the first power line 23 and the second power line 33 are connected to supply power to both the devices for vehicle driving and the devices for general purposes or for user convenience.

That is, the first loads are connected to receive the first power through the first power line and the second power through the first redundancy power line, and the second loads are connected to receive power only through the first power line. Also, the third loads are connected to receive the third power through the second power line and the fourth power through the second redundancy power line, and the fourth loads are connected to receive power only through the second power line.

Although combined power of the first power and the second power is supplied to the first loads in a normal state, if a failure (e.g., a failure or short-circuit) of the first converter occurs, the first switch may be turned off, the first loads receive only the second power because the first power is blocked, and the power supply to the second loads is blocked.

Also, although combined power of the third power and the fourth power is supplied to the third loads in a normal state, if a failure (e.g., a failure or short-circuit) of the second converter occurs, the third switch may be turned off, the third loads receive only the fourth power because the third power is blocked, and the power supply to the fourth loads is blocked.

Here, each of the combined power of the first power and the second power and the combined power of the third power and the fourth power may be an amount of power required for respective devices to operate at full power, and each of the second power and the fourth power may be an amount of power corresponding to restricted power (e.g., power restricted to be less than the full power due to function restriction) in a redundancy power situation.

In this example, an interior power distributor 19a is connected to the first power system and the second power system to supply power to electronic devices of an interior 19 of the vehicle.

The interior power distributor 19a connects the first power line 23 and the second power line 33 to the interior electronic devices for general purposes or for convenience and the interior electronic devices for vehicle driving and connects the first redundancy power line 24 and the second redundancy power line 34 to the interior devices for vehicle driving.

As illustrated in FIG. 1, the first redundancy power line 24 and the second redundancy power line 34 are connected, via the interior power distributor 19a, only to the interior devices for vehicle driving and do not supply power to other devices. However, aspects of the present disclosure are not limited thereto.

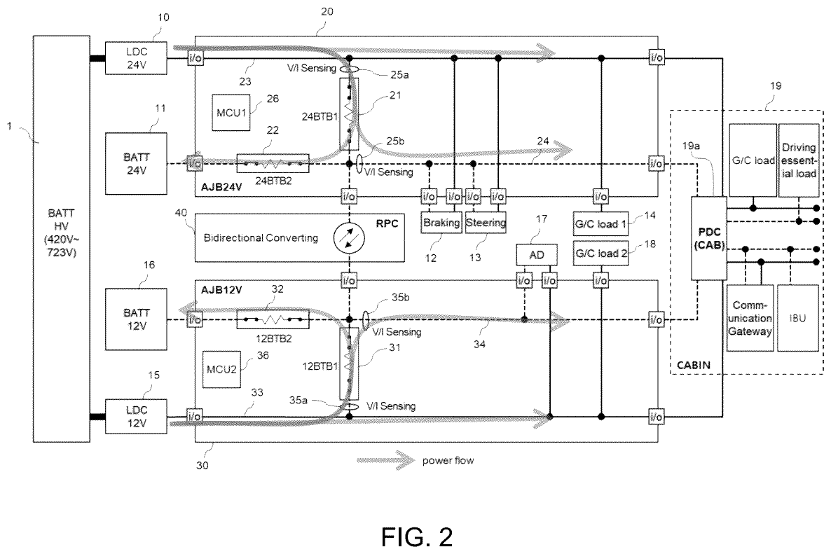

FIG. 2 is a view illustrating an example of a current flow during driving in a normal state.

As illustrated in FIG. 2, in the normal state, each of the first switch 21, the second switch 22, the third switch 31, and the fourth switch 32 maintains an on-state (closed state).

Thus, the 24V power converted by the first converter 10 may be supplied to the first voltage loads through the first power line 23.

Also, the 24V power output by the first converter 10 is used to charge the first battery 11 through the first switch 21 and the second switch 22.

The 12V power converted by the second converter 15 may be supplied to the second voltage loads through the second power line 33. The 12V power output by the second converter 15 is used to charge the second battery 16 through the third switch 31 and the fourth switch 32.

FIG. 3 is a view illustrating an example of a redundancy power supply situation in a failure state of the first converter 10, which will be described below.

The first controller 26 may diagnose the failure state of the first converter 10 through the first sensor 25a or through information received from a controller of the first converter 10, and control the first switch 21 to be switched to an off-state (open state) in the failure state.

Also, the first controller 26 transmits a power conversion request signal to the bidirectional converter 40.

The bidirectional converter 40 converts power of the second voltage into the first voltage and supplies the converted first voltage to the first power distributor 20.

That is, the power supplied from the bidirectional converter 40 is used to charge the first battery 11 and supplied to the first voltage loads through the first redundancy power line 24.

Here, the first controller 26 transmits failure information of the first converter 10, and accordingly, an instrument cluster may output a notification based on the failure information.

FIG. 4 is a view illustrating an example of a state in which a short-circuit occurs in an electrical connection between the first converter 10 and the first power distributor 20, which will be described below.

When the first converter 10 is in the above-described short-circuit state, the first controller 26 switches the first switch 21 to the off-state.

Also, the first controller 26 transmits a power conversion request signal to the bidirectional converter 40.

According to the power conversion request signal, the bidirectional converter 40 converts power of the second voltage into the first voltage and supplies the converted first voltage to the first power distributor 20.

The power supplied from the bidirectional converter 40 is used for charging the first battery and also supplied to the first voltage loads through the first redundancy power line 24.

Here, the first controller 26 transmits short-circuit information of the first converter 10, and accordingly, the instrument cluster may output a notification based on the corresponding information.

FIG. 5 is a view illustrating an example of a state in which a short-circuit occurs in an electrical connection between the first battery 11 and the first power distributor 20, which will be described below.

If the above-described short-circuit occurs, the first controller 26 switches the second switch 22 to an off-state to prevent power output from the first converter 10 from being supplied to the second battery 16 and supply the power to the first voltage loads through the first redundancy power line 24.

The current output from the first converter 10 is supplied to the first voltage loads through the first power line 23 and/or the first redundancy power line 24.

Likewise, the first controller 26 transmits short-circuit state information of the first battery 11, and accordingly, the instrument cluster may output a notification based on the short-circuit state information.

FIG. 6 is a view illustrating an example of a redundancy power supply in case of a failure state of the second converter 15.

The second controller 36 may diagnose the failure state of the second converter 15 through a third sensor 35a or through information received from a controller of the second converter 15.

The second controller 36 switches the third switch 31 to the off-state in case of the failure state of the second converter 15 and transmits a power conversion request signal to the bidirectional converter 40.

In response to the power conversion request signal from the second controller 36, the power of the first voltage is converted into the second voltage by the bidirectional converter 40 and supplied to the second power distributor 30.

That is, the power supplied from the bidirectional converter 40 is used for charging the second battery 16 and also supplied to the second voltage loads through the second redundancy power line 34.

Here, the second controller 36 transmits the failure information of the second converter 15, and accordingly, the instrument cluster may output a notification based on the failure information.

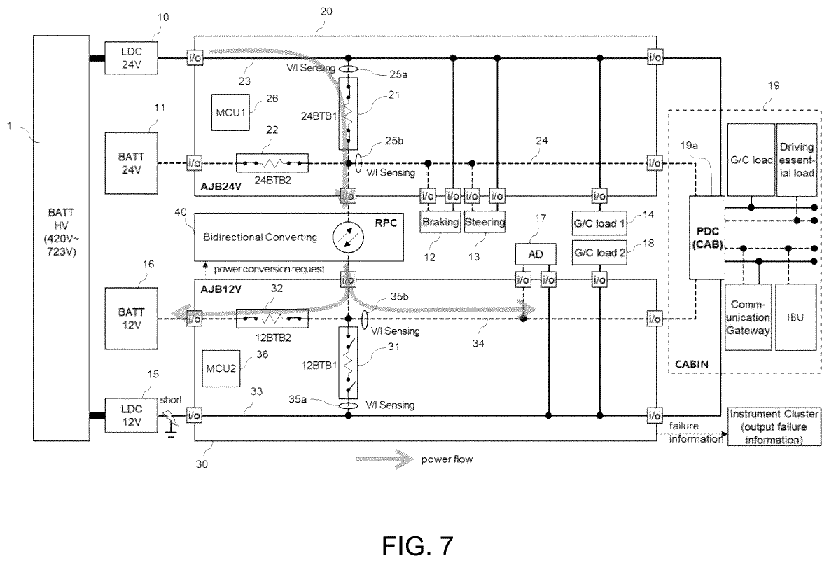

FIG. 7 is a view illustrating an example of a state in which a short-circuit occurs in an electrical connection between the second converter 15 and the second power distributor 30, which will be described below.

If the second converter 15 is in the above-described short-circuit state, the second controller 36 switches the third switch 31 to the off-state.

Also, the second controller 36 transmits a power conversion request to the bidirectional converter 40.

According to the power conversion request, the bidirectional converter 40 converts the power of the first voltage into the second voltage and supplies the converted second voltage to the second power distributor 30.

The power supplied from the bidirectional converter 40 is used for charging the second battery 16 and also supplied to the second voltage loads through the second redundancy power line 34.

Also, the second controller 36 transmits short-circuit information of the second converter 15, and accordingly, the instrument cluster may output a notification based on the short-circuit state information.

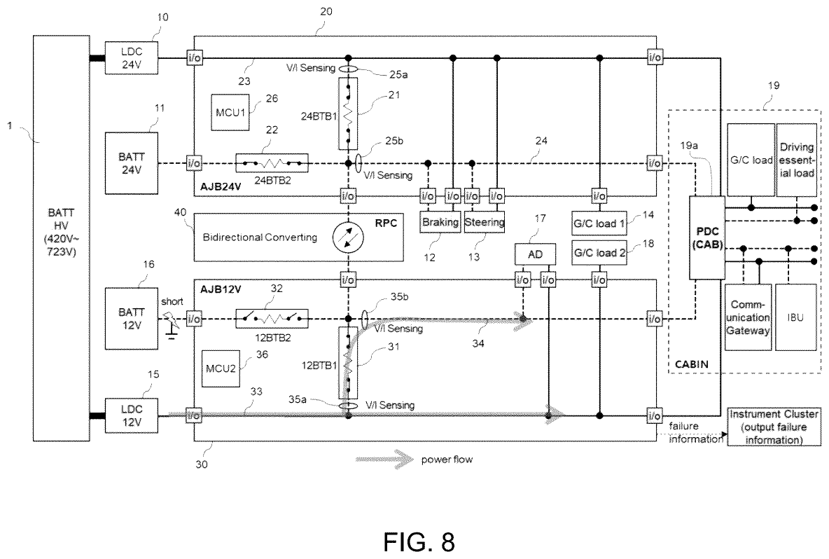

FIG. 8 is a view illustrating an example of a state in which a short-circuit occurs in an electrical connection between the second battery 16 and the second power distributor 30, which will be described below.

If the above-described short-circuit occurs, the second controller 36 switches the fourth switch 32 to an off-state to prevent power output from the second converter 15 from being supplied to the second battery 16 and supply the power to the second voltage loads through the second redundancy power line 34.

The current output from the second converter 15 is supplied to the second voltage loads through the second power line 33 and/or the second redundancy power line 34.

Likewise, the second controller 36 transmits short-circuit state information of the second battery 16, and accordingly, the instrument cluster may output a notification based on the short-circuit state information.

FIG. 9 is a view illustrating another example of a current flow in case of the failure state of the first converter 10.

In this example, the first controller 26 maintains the first switch 21 in an on-state when a request signal is received from the autonomous driving system 17 (e.g., autonomous driving controller) in the failure state of the first converter 10.

For example, when a significant torque is required by the steering device 13 in a low-speed autonomous driving state, in order to supply sufficient power, power greater than the second power, e.g., combined power of the first power and second power for full-power operation, may be supplied through the first power line 23 and the first redundancy power line 24. In this example, the steering device 13 and the braking device 12 may receive power through the first power line 23 and the first redundancy power line 24, and the requested maximum power output may be provided as the combined power is supplied by the two power lines. However, in the redundancy state, power supply through the first power line 23 may be blocked when the first switch is turned off, and thus the maximum power output may not be produced. Thus, when sufficient power supply is required even in the redundancy state, the current flow through the first power line 23 is maintained even if the failure or short-circuit state of the first converter 10 is detected.

Also, in case of a minimum risk maneuver (MRM) situation, e.g., an emergency situation that requires parking at a shoulder or entering a highway tollgate, the autonomous driving controller may transmit a request signal for the first controller 26 to maintain the first switch 21 in the on-state in order to prevent the output of the steering device 13 and/or braking device 12 from being dropped due to the redundancy situation.

Also, the first controller 26 may transmit a power conversion request signal to the bidirectional converter 40.

The power of the second voltage may be converted to the first voltage and supplied to the first power distributor 20 by the bidirectional converter 40.

That is, the power supplied from the bidirectional converter 40 may be used for charging the first battery 11 and also supplied to the first voltage loads through the first power line 23 and/or the first redundancy power line 24.

Here, the first controller 26 transmits failure information of the first converter 10, and accordingly, the instrument cluster may output a notification based on the failure information.

FIG. 10 is a view illustrating another embodiment of a current flow of the failure state of the second converter 15, which will be described below.

In this example, the second controller 36 maintains the third switch 31 in the on-state when a request signal is received from the autonomous driving system 17 in the failure state of the second converter 15.

Also, the second controller 36 may transmit a power conversion request signal to the bidirectional converter 40.

The power of the first voltage is converted into the second voltage by the bidirectional converter 40 and supplied to the second power distributor 30.

The power supplied from the bidirectional converter 40 is used for charging the second battery 16 and also supplied to the second voltage loads through the second power line 33 and/or the second redundancy power line 34.

Here, the second controller 36 transmits failure information of the second converter 15, and accordingly, the instrument cluster may output a notification based on the failure information.

In the examples of FIGS. 9 and 10, there may be driving environments where key loads related to autonomous driving (particularly steering and braking) require full-functional operation rather than the redundancy operation. For this reason, the autonomous driving system 17 may transmit a request signal to the first controller 26 or the second controller 36, as described above, to ensure power supply through the first power line 23 and the second power line 33 for the full operation of the relevant devices even if a failure and/or a short-circuit is detected at the first converter 10 or the second converter 15.

For example, in poor weather conditions such as rainy roads, snowfall, or sub-zero temperatures, the steering device 13 and braking device 12 may operate in full functionality even in the event of a fault in the first converter 10 or the second converter 20, thereby ensuring driving safety in poor driving conditions (e.g., poor weather conditions).

In the examples shown in FIGS. 9 and 10, if the controller of the first converter 10 or the second converter 15 remains operational, the conversion function of the respective converter may automatically block its output and actively switch off the circuits connected to the vehicle, even in the event of a fault.

The present disclosure provides a power control system including: a first converter configured to convert a voltage of a high-voltage battery into a first voltage; a first battery; a first power distributor configured to distribute power output from the first converter to the first battery and first voltage loads; a second converter configured to convert the voltage of the high-voltage battery into a second voltage; a second battery; a second power distributor configured to distribute power output from the second converter to the second battery and second voltage loads; and a bidirectional converter connected between the first power distributor and the second power distributor, wherein the first power distributor and/or the second power distributor comprises at least one switch and is configured to control the at least one switch to be turned on or off in response to occurrence of a predetermined failure.

The at least one switch may include a first switch configured to turn on or off an electrical connection between the bidirectional converter and the first converter.

The first switch may be turned off in response to occurrence of a failure or short-circuit in the first converter.

The first switch may be maintained in an on-state in response to a request of another controller being received with a failure or short-circuit in the first converter.

The at least one switch may include a second switch configured to turn on or off an electrical connection between the first converter or the bidirectional converter and the first battery.

The second switch may be turned off in response to occurrence of a failure or complete discharge of the first battery.

The at least one switch may include a third switch configured to turn on or off an electrical connection between the second converter and the bidirectional converter.

The third switch may be turned off in response to occurrence of a failure or short-circuit in the second converter.

The third switch may be maintained in an on-state in response to a request of another controller being received with a failure or short-circuit in the second converter.

The at least one switch may include a fourth switch configured to turn on or off an electrical connection between the second converter or the bidirectional converter and the second battery.

The fourth switch may be turned off in response to occurrence of a failure or complete discharge of the second battery.

The bidirectional converter may convert the second voltage into the first voltage in response to occurrence of a failure or short-circuit in the first converter.

The bidirectional converter may convert the first voltage into the second voltage when the failure or short-circuit state of the second converter occurs.

The first voltage loads may include at least one first essential load that is set as being essential for driving and at least one first non-essential load that is set as being not essential, and the first power distributor may include a first power line configured to connect the first converter to the entire first voltage loads and a first redundancy power line configured to connect the first battery and the bidirectional converter in parallel to the at least one first essential load.

The at least one switch may include a first switch connected between the first power line and the first redundancy power line, in a normal operation state of the first converter, the first switch may be maintained in an on-state, the at least one first essential load may receive first power through the first power line and second power through the first redundancy power line, and the at least one first non-essential load may receive power through the first power line, and in response to occurrence of a failure or short-circuit in the first converter, the first switch may be turned off, and the first power supplied to the at least one first essential load may be blocked while supply of the second power is maintained.

The at least one first essential load may include at least one of a steering device, a braking device, an integrated body-control unit (IBU), or a communication gateway, and the at least one first non-essential load may include at least one of an air conditioner, an audio video navigation (AVN), a cabin lighting device, a seat position adjustment device, or a seat heating wire.

The second voltage loads may include at least one second essential load that is set as being essential for driving and at least one second non-essential load that is set as being not essential, and the second power distributor may include a second power line configured to connect the second converter to the entire second voltage loads and a second redundancy power line configured to connect the second battery and the bidirectional converter in parallel to the at least one second essential load.

The at least one switch may include a third switch connected between the second power line and the second redundancy power line, in a normal operation state of the second converter, the third switch may be maintained in an on-state, the at least one second essential load may receive third power through the second power line and fourth power through the second redundancy power line, and the at least one second non-essential load may receive power through the second power line, and in response to occurrence of a failure or short-circuit in the second converter, the third switch may be turned off, and the third power supplied to the at least one second essential load may be blocked while supply of the fourth power is maintained.

The at least one second essential load may include an autonomous driving system.

A vehicle may include: a high-voltage battery; a first converter configured to convert a voltage of the high-voltage battery into a first voltage; a first battery; a first power distributor configured to distribute power output from the first converter to the first battery and first voltage loads; a second converter configured to convert the voltage of the high-voltage battery into a second voltage; a second battery; a second power distributor configured to distribute power output from the second converter to the second battery and second voltage loads; and a bidirectional converter connected between the first power distributor and the second power distributor, in which the first power distributor and/or the second power distributor includes at least one switch and controls the at least one switch to be turned on or off in response to occurrence of a predetermined failure.

According to one or more aspects of the present disclosure, the redundancy power supply technology capable of managing various failure states may be obtained.

Also, according to one or more aspects of the present disclosure, the connected power supply line may be effectively blocked, and the redundancy power may be supplied when the failure occurs in the converter or the battery that receives power from the converter.

Also, according to one or more aspects of the present disclosure, the loss of power and the occurrence of fire may be prevented by blocking the connected power line in case of the failure or short-circuit state of the converter or the battery.

Also, according to one or more aspects of the present disclosure, the entire autonomous vehicle may be operated although the failure (short-circuit) occurs in the circuit to which the low-voltage battery and the power system are connected.

Also, according to one or more aspects of the present disclosure, the limitation such as side effects caused by increased control complexity may be relieved or resolved by using the bidirectional converter to obtain the cost reduction and the packaging efficiency.

Although the exemplary embodiment(s) of the present invention have been described, it should be understood that aspects of the present invention should not be limited to these exemplary embodiment(s) but various changes and modifications can be made by one ordinary skilled in the art within the spirit and scope of the present invention as hereinafter claimed. Hence, the real protective scope of the present invention shall be determined by the technical scope of the accompanying claims.

What is claimed is:

1. A power control system comprising:
a first connector configured to be connected with a first battery;
a first converter configured to convert a voltage of a main battery to a first voltage, wherein the first voltage corresponds to a voltage of the first battery;
a first power distributor configured to distribute power output from the first converter to the first battery and first voltage loads;
a second connector configured to be connected with a second battery;
a second converter configured to convert the voltage of the main battery to a second voltage different from the first voltage, wherein the second voltage corresponds to a voltage of the second battery;
a second power distributor configured to distribute power output from the second converter to the second battery and second voltage loads; and
a bidirectional converter connected between the first power distributor and the second power distributor,
wherein at least one of the first power distributor or the second power distributor comprises at least one switch and is configured to control the at least one switch to be turned on or off in response to a failure associated with at least one circuit element.

2. The power control system of claim 1, wherein the at least one switch of the first power distributor comprises a first switch configured to electrically connect the bidirectional converter with the first converter or electrically disconnect the bidirectional converter from the first converter.

3. The power control system of claim 2, wherein the first switch is configured to be turned off to electrically disconnect the bidirectional converter from the first converter in response to a failure or short-circuit in the first converter.

4. The power control system of claim 2, wherein the power control system is configured to maintain, during a failure or short-circuit in the first converter, the first switch in an on-state in response to a signal from a controller.

5. The power control system of claim 1, wherein the at least one switch of the first power distributor comprises a second switch configured to:
electrically connect the first battery with the first converter or the bidirectional converter; or
electrically disconnect the first battery from the first converter or the bidirectional converter.

6. The power control system of claim 5, wherein the second switch is configured to be turned off in response to a failure or complete discharge of the first battery.

7. The power control system of claim 1, wherein the at least one switch of the second power distributor comprises a third switch configured to electrically connect the second converter with the bidirectional converter or electrically disconnect the second converter from the bidirectional converter.

8. The power control system of claim 7, wherein the third switch is configured to be turned off to electrically disconnect the second converter from the bidirectional converter in response to a failure or short-circuit in the second converter.

9. The power control system of claim 7, wherein the power control system is configured to maintain, during a failure or short-circuit in the second converter, the third switch in an on-state in response to a signal from a controller.

10. The power control system of claim 1, wherein the at least one switch of the second power distributor comprises a fourth switch configured to:
electrically connect the second battery with the second converter or the bidirectional converter; or
electrically disconnect the second battery from the second converter or the bidirectional converter.

11. The power control system of claim 10, wherein the fourth switch is configured to be turned off in response to a failure or complete discharge of the second battery.

12. The power control system of claim 1, wherein the bidirectional converter is configured to convert the second voltage to the first voltage in response to a failure or short-circuit in the first converter.

13. The power control system of claim 1, wherein the bidirectional converter is configured to convert the first voltage to the second voltage in response to a failure or short-circuit in the second converter.

14. The power control system of claim 1, wherein the first voltage loads comprise at least one first load associated with vehicle driving and at least one second load associated with a vehicle function other than vehicle driving, and
wherein the first power distributor comprise a first main power line configured to connect the first converter to each load of the first voltage loads and a first redundancy power line configured to connect the first battery and the bidirectional converter in parallel to the at least one first load.

15. The power control system of claim 14, wherein:
the at least one switch of the first power distributor comprises a first switch connected between the first main power line and the first redundancy power line,
absence of a failure or short-circuit in the first converter, the first switch is configured to be maintained in an on-state, the at least one first load is configured to receive first power through the first main power line and second power through the first redundancy power line,
and the at least one second load is configured to receive power through the first main power line, and
in response to a failure or short-circuit in the first converter, the first switch is configured to be turned off, and the first power supplied to the at least one first load is blocked while supply of the second power is maintained.

16. The power control system of claim 14, wherein the at least one first load comprises at least one of a steering device, a braking device, an integrated body-control unit (IBU), or a communication gateway, and
wherein the at least one second load comprises at least one of an air conditioner, an audio video navigation (AVN), a cabin lighting device, a seat position adjustment device, or a seat heating wire.

17. The power control system of claim 1, wherein the second voltage loads comprise at least one third load associated with vehicle driving and at least one fourth load associated with a vehicle function other than vehicle driving, and
wherein the second power distributor comprise a second main power line configured to connect the second converter to each load of the second voltage loads and a second redundancy power line configured to connect the second battery and the bidirectional converter in parallel to the at least one third load.

18. The power control system of claim 17, wherein:
the at least one switch of the second power distributor comprises a third switch connected between the second main power line and the second redundancy power line,
absence of a failure or short-circuit in the second converter, the third switch is configured to be maintained in an on-state, the at least one third load is configured to receive third power through the second main power line and fourth power through the second redundancy power line, and the at least one fourth load is configured to receive power through the second main power line,
in response to a failure or short-circuit in the second converter, the third switch is configured to be turned off, and the third power supplied to the at least one third load is blocked while supply of the fourth power is maintained, and
the at least one third load comprises an autonomous driving system.

19. A vehicle comprising:
a main battery;
a first battery;
a first converter configured to convert a voltage of the main battery to a first voltage, wherein the first voltage corresponds to a voltage of the first battery;
a first power distributor configured to distribute power output from the first converter to the first battery and first voltage loads;
a second battery;
a second converter configured to convert the voltage of the main battery to a second voltage different from the first voltage, wherein the second voltage corresponds to a voltage of the second battery;
a second power distributor configured to distribute power output from the second converter to the second battery and second voltage loads; and
a bidirectional converter connected between the first power distributor and the second power distributor,
wherein at least one of the first power distributor or the second power distributor comprises at least one switch and is configured to control the at least one switch to be turned on or off in response to occurrence of a failure associated with at least one circuit element of the vehicle.

20. A power control system for a vehicle, the power control system comprising:
a first power distributor configured to distribute power to first voltage loads via at least one of a plurality of first power lines, wherein the first power distributor comprises:
a first connector configured to be connected with a first battery, wherein a voltage of the first battery corresponds to a first voltage; and
a second connector configured to receive first power from a first converter configured to convert a voltage of a main battery to the first voltage;
a second power distributor configured to distribute power to second voltage loads via at least one of a plurality of second power lines, wherein the second power distributor comprises:
a third connector configured to be connected with a second battery, wherein a voltage of the second battery corresponds to a second voltage different from the first voltage; and
a fourth connector configured to receive second power from a second converter configured to convert the voltage of the main battery to the second voltage; and
a bidirectional converter connected between the first power distributor and the second power distributor, wherein the bidirectional converter is configured to:
based on a failure associated with power supply via the second connector, provide power from the second power distributor to the first power distributor; and
based on a failure associated with power supply via the fourth connector, provide power from the first power distributor to the second power distributor.
